(19) United States
(12) Patent Application Publication
(10) Pub. No.: US 2025/0336318 A1
(43) Pub. Date: Oct. 30, 2025

(54) CONTROL SYSTEM AND CONTROL METHOD

(71) Applicant: JVCKENWOOD Corporation, Yokohama-shi (JP)

(72) Inventors: Koichi MATSUMOTO, Yokohama-shi (JP); Atsuko YAMAGUCHI, Yokohama-shi (JP); Genta KAWAKAMI, Yokohama-shi (JP); Taiji KIKUCHI, Yokohama-shi (JP); Ryo MIYAKUCHI, Yokohama-shi (JP); Ryotaro FUTAMURA, Yokohama-shi (JP)

(21) Appl. No.: 19/261,106

(22) Filed: Jul. 7, 2025

Related U.S. Application Data
(63) Continuation-in-part of application No. PCT/JP2023/045698, filed on Dec. 20, 2023.

(30) Foreign Application Priority Data
Jan. 26, 2023 (JP) 2023-010281

(51) Int. Cl. G09F 21/08; G05D 1/689; G05D 1/695; G05D 105/70; G05D 109/20; G05D 111/10; G06V 10/60; G06V 20/17; G06V 40/10

(52) U.S. Cl. CPC G09F 21/08; G05D 1/689; G05D 1/695; G06V 10/60; G06V 20/17; G06V 40/10; G05D 2105/70; G05D 2109/20; G05D 2111/10; G06V 2201/07

(57) ABSTRACT

A control system according to the present disclosure includes a drone configured to be movable in a space and a control apparatus configured to control the drone. The drone includes a display unit configured to perform display at a predetermined position in the space, and an illuminance sensor configured to detect illuminance of the display unit in a rear direction thereof which is a direction substantially opposite to a direction in which the display unit performs display. The control apparatus moves the drone to a position different from the predetermined position when the illuminance is equal to or greater than a threshold.

### CROSS REFERENCE TO RELATED APPLICATION

This application is a Bypass Continuation Application of PCT Application No. PCT/JP2023/045698 filed on Dec. 20, 2023, which is based upon and claims the benefit of priority from Japanese patent application No. 2023-10281, filed on Jan. 26, 2023, the disclosure of which is incorporated herein in its entirety by reference.

### BACKGROUND

The present disclosure relates to a control system and a control method.

Technologies for displaying information such as advertisements by using an air vehicle flying in a space are known. As a technology related to the above technologies, for example, Patent Literature 1 discloses a flying type in-store advertising system which advertises a commodity, an event, or the like to many customers dispersed to respective counters while flying above an in-store passage.

Patent Literature 1: Japanese Patent No. 6080143

### SUMMARY

For example, it is assumed that a drone including a display panel using a Light Emission Diode (LED) or the like flies in the sky and displays an advertisement to a target person on the ground. The sun may be positioned behind the display panel when seen from the target person depending on the time of day or the weather, and hence the display panel may be brought to a backlit state. In such a case, since it is difficult for the target person to see the contents of the advertisement, appropriate information cannot be provided to the target person.

A control method according to the present disclosure is a control method for controlling a drone configured to be movable in a space and perform display at a predetermined position,
in which when illuminance in a direction substantially opposite to a direction in which the drone performs display is equal to or greater than a threshold, the drone is moved to a position different from the predetermined position.

A control method according to the present disclosure is a control method for controlling a drone configured to be movable in a space and perform display at a predetermined position,
in which at least one of a display brightness and a display color in the drone is controlled based on the illuminance in the direction substantially opposite to the direction in which the drone performs display or a color of a subject in an image obtained by capturing the space in the direction substantially opposite to the direction in which the drone performs display.

A control system according to the present disclosure is a control system including a drone configured to be movable in a space and a control apparatus configured to control the drone, in which
the drone includes:
   a display unit configured to perform display at a predetermined position in the space; and
   an illuminance sensor configured to detect illuminance of the display unit in a rear direction thereof which is a direction substantially opposite to a direction in which the display unit performs display, and
the control apparatus moves the drone to a position different from the predetermined position when the illuminance is equal to or greater than a threshold.

A control system according to the present disclosure is a control system including a drone configured to be movable in a space and a control apparatus configured to control the drone, in which
the drone includes:
   a display unit configured to perform display at a predetermined position in the space;
   an illuminance sensor configured to detect illuminance of the display unit in a rear direction thereof which is a direction substantially opposite to a direction in which the display unit performs display; and
   a color sensor configured to capture an image of the space in the rear direction and detect a color of a subject, and
the control apparatus controls at least one of a display brightness and a display color of the display unit based on the illuminance or the color of the subject.

### BRIEF DESCRIPTION OF THE DRAWINGS

The above and other aspects, advantages and features will be more apparent from the following description of certain embodiments taken in conjunction with the accompanying drawings, in which:

FIG. 1 is a block diagram showing a configuration of a control system according to a first embodiment;

FIG. 2 is a diagram showing an external appearance of a drone according to the first embodiment;

FIG. 3 is a block diagram showing an internal configuration of the drone according to the first embodiment;

FIG. 4 is a diagram showing an example of a method for attaching an illuminance sensor according to the first embodiment;

FIG. 5 is a diagram showing another example of the method for attaching an illuminance sensor according to the first embodiment;

FIG. 6 is a block diagram showing a configuration of a control apparatus according to the first embodiment;

FIG. 7 is a diagram showing an example of a drone formation formed by a plurality of drones according to the first embodiment;

FIG. 8 is a diagram showing an example of information displayed by the drone formation according to the first embodiment;

FIG. 9 is a sequence diagram showing control processing performed by the control system according to the first embodiment;

FIG. 10 is a block diagram showing a configuration of a control apparatus according to a second embodiment; and

FIG. 11 is a sequence diagram showing processes performed by a control system according to the second embodiment.

### DETAILED DESCRIPTION

Embodiments of the present disclosure will be described hereinafter in detail with reference to the drawings. The same or corresponding elements are denoted by the same reference symbols throughout the drawings. Redundant descriptions will be omitted as necessary for the clarification of the description.

### First Embodiment

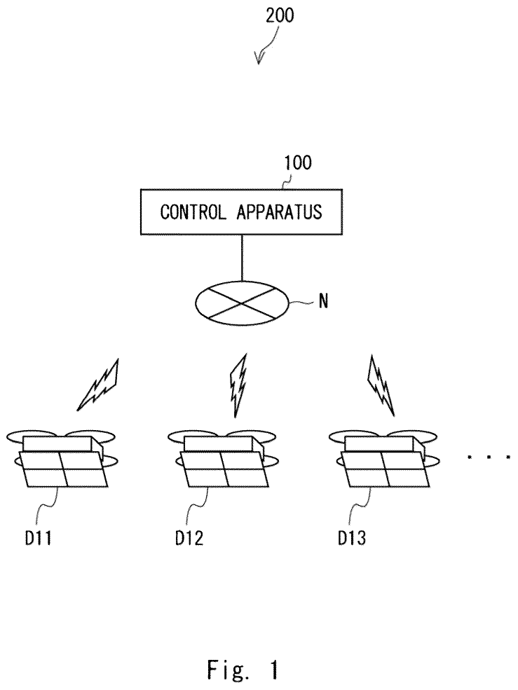

First, a control system 200 according to a first embodiment will be described with reference to FIG. 1. FIG. 1 is a block diagram showing a configuration of the control system 200 according to the first embodiment.

### (Configuration of the Control System 200)

The control system 200 includes a plurality of drones D11, D12, D13, . . . , and a control apparatus 100 that controls these drones. Each of the plurality of drones D11, D12, D13, . . . is connected to the control apparatus 100 through a network N. Notet that the network N is a wired or wireless communication line. The network N may be configured using, for example, a personal area network, a mesh network, a mobile communication network such as 3G, 4G, or 5G, the Internet, a public telephone line network, or a satellite communication network.

Each of the plurality of drones D11, D12, D13, . . . is, for example, a drone which can fly autonomously in a space. In place of a drone, another mobile body may be used. For example, an air vehicle such as an aircraft may be used. Further, in this embodiment, although a description will be given with reference to an example in which a space where mobile bodies are to be moved is in the atmosphere, the space where mobile bodies are to be moved may be on the ground, in the water, or the like.

Since configurations of the plurality of drones D11, D12, D13, . . . are similar to one another, each of the plurality of drones D11, D12, D13, . . . may be simply referred to as a “drone D” in the following description. Note that the number of drones D is not limited to three.

### (Configuration of the Drone D)

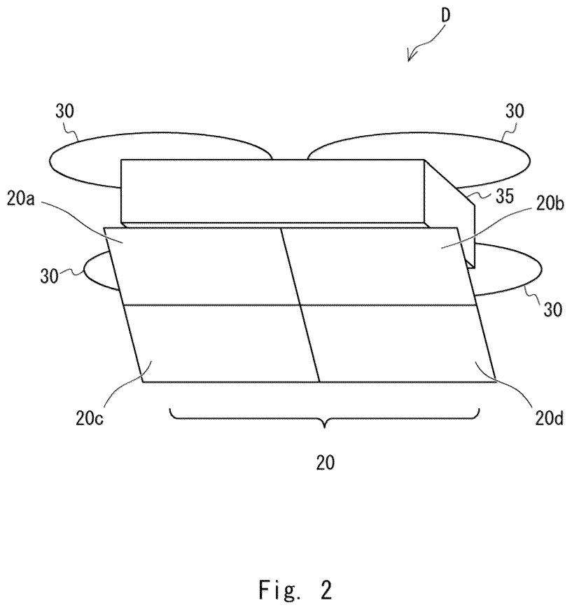

Next, a configuration of the drone D will be described with reference to FIGS. 2 to 5. First, an external appearance of the drone D will be described with reference to FIG. 2. FIG. 2 is a diagram showing the external appearance of the drone D.

As shown in FIG. 2, the drone D includes a main body part 35, a propeller part 30, and a display panel 20. The drone D is configured so that it can move up and down, turn left and right, and move forward and backward by rotation of the propeller part 30 attached to the main body part 35. By this configuration, the drone D moves in the space. Note that the number of the propeller parts 30 is not limited to four.

In this embodiment, although the propeller part 30 is used as moving means for a drone to move in the space, the moving means is not limited thereto. The moving means may be, for example, a driving mechanism for a drone to move on the ground, on the water surface, in the water, or the like in accordance with the form of the drone.

The display panel 20 is a display unit for displaying information. The display panel 20 performs display at a predetermined position in a space where the drone D is located. The display panel 20 includes four light emitting units 20a to 20d. The light emitting units 20a to 20d form one display surface. Thus, the display panel 20 is formed in a planar shape. The number of light emitting units is not limited to four. For example, the display panel 20 may include only one light emitting unit.

Each of the light emitting units 20a to 20d may be composed of, for example, an LED, a liquid crystal, an organic Electro-Luminescence (EL), or an inorganic EL. The light emitting units 20a to 20d may be integrally formed, and each of them may instead be configured so as to be detachable.

Note that, in this embodiment, a description will be given with reference to an example of the planar display panel 20 as shown in FIG. 2. However, the form of the display unit is not limited thereto. Various display apparatuses having forms other than the above one may be used for the display unit. For example, the display panel 20 may be formed in a rectangular parallelepiped shape.

The display panel 20 displays display information to a target person by using colors, images, blinking, or the like. Note that the target person is a person by whom display is to be visually recognized. For example, it is assumed that the control system 200 performs display for informing the target person about the occurrence of a disaster in an area where the disaster has occurred. In this case, the target person is a person in the area where the disaster has occurred. Further, for example, in a case where the control system 200 displays an advertisement in a store, the target person is a customer or the like in the store. The above cases are merely examples, and the target person is not limited thereto.

The four light emitting units 20a to 20d can perform display in modes different from one another in accordance with the control performed by the display control unit 13 described later. For example, the light emitting units 20a to 20d can display colors different from one another. Further, the light emitting units 20a to 20d can be turned on and off at timings different from one another. Therefore, the light emitting units 20a to 20d can blink at timings different from one another.

Thus, a plurality of types of information can be displayed by one drone D. Further, when a plurality of drones D are assembled to form a formation, a larger amount of information can be displayed. Note that all of the light emitting units 20a to 20d may perform the same display or some of them may perform the same display.

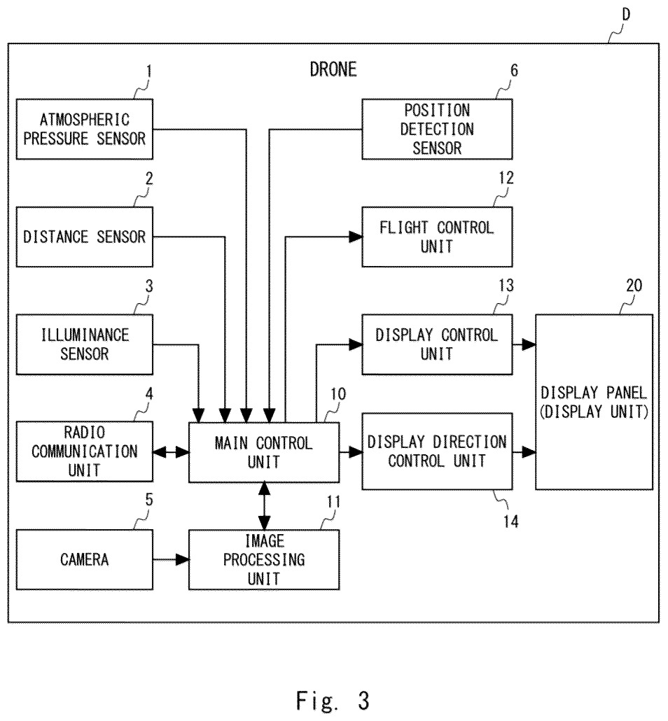

Next, an internal configuration of the drone D according to this embodiment will be described with reference to FIG. 3. FIG. 3 is a block diagram showing the internal configuration of the drone D. As shown in FIG. 3, the drone D includes an atmospheric pressure sensor 1, a distance sensor 2, an illuminance sensor 3, a radio communication unit 4, a camera 5, a position detection sensor 6, a main control unit 10, an image processing unit 11, a flight control unit 12, a display control unit 13, a display direction control unit 14, and the display panel 20.

The drone D and the control apparatus 100 includes, as components that are not shown, a processor, a memory, and a storage device. The storage device stores a computer program in which processing according to this embodiment is implemented. The processor may load the computer program from the storage device into the memory and execute the loaded computer program. As a result, the processor implements the functions of the functional units included in the drone D and the control apparatus 100.

Further, the functional units included in the drone D and the control apparatus 100 may be implemented by dedicated hardware. Further, some or all of the components of each apparatus may be implemented by a general-purpose or dedicated circuitry, processor, etc., or a combination thereof. These components may be formed by a single chip or by a plurality of chips connected to each other through a bus. Some or all of the components of each apparatus may be implemented by a combination of the above-mentioned circuitry etc. and a program. Further, a Central Processing Unit (CPU), a Graphics Processing Unit (GPU), a field-programmable gate array (FPGA), a quantum processor (a quantum computer control chip), or the like may be used as the processor.

The atmospheric pressure sensor 1 detects atmospheric pressure in a surrounding area. By the detected atmospheric pressure, the altitude of the drone D can be detected. The distance sensor 2 detects a distance between the drone D and an object. The distance sensor 2 detects, for example, a distance between the drone D and another drone. The drone D can adjust its position using results of the detection by the atmospheric pressure sensor 1 and the distance sensor 2.

The illuminance sensor 3 detects illuminance in an area near the drone D. The illuminance sensor 3 may be provided on the rear side of the display panel 20. Note that the rear side of the display panel 20 indicates a side thereof opposite to the display surface formed by the light emitting units 20a to 20d. By the above configuration, the illuminance sensor 3 detects illuminance of the display panel 20 in the rear direction thereof which is a direction substantially opposite to a direction in which the display panel 20 performs display.

Note that, in the present disclosure, the term “substantially” refers not only to a state of being exactly the same, but also to a state that includes errors within a range that does not lose identity. Therefore, for example, the “direction substantially opposite to a direction in which the display panel 20 performs display” is not limited to a direction different from the direction in which the display panel 20 performs display by exactly 180 degrees. Similarly, the terms “substantially parallel”, “substantially perpendicular”, and the like described later refer not only to a state of being exactly the same, but also to a state of having some errors. On the contrary, for example, even when the term “opposite side” or the like is simply used, it does not refer only to the exact opposite side, but may have some errors.

### (Method for Attaching the Illuminance Sensor 3)

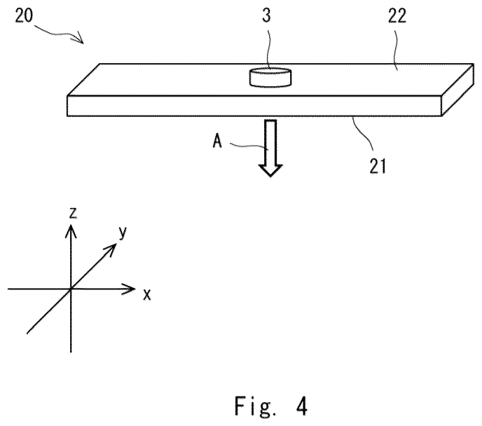

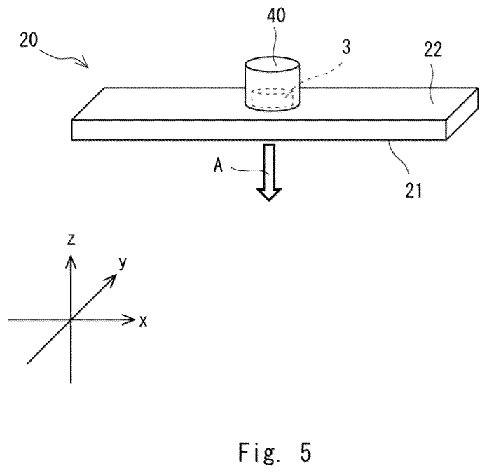

A method for attaching the illuminance sensor 3 will be described with reference to FIG. 4. FIG. 4 is a diagram showing an example of a method for attaching the illuminance sensor 3. Right-handed xyz coordinates shown in FIG. 4 are shown only for the sake of convenience to explain positional relations among the components, and the same applies to FIG. 5.

In FIG. 4, the z-axis positive direction indicates a vertically upward direction, while the z-axis negative direction indicates a vertically downward direction. Further, the z-axis negative direction indicates a display direction A in which the display panel 20 performs display. A target person is present in the display direction A. Note that although it is assumed here that the display direction A is a vertically downward direction for the sake of explanation, the display direction A may be changed as appropriate in accordance with the position of a target person.

Further, in FIG. 4, the display panel 20 is shown in parallel with the xy plane. The display panel 20 includes a display surface 21, which is a side thereof in the display direction A, and a rear surface 22, which is a side thereof opposite to the display surface 21. As shown in FIG. 4, the illuminance sensor 3 is attached to the display panel 20 on the rear surface 22 side thereof. Thus, the illuminance sensor 3 detects illuminance of the display panel 20 in the rear direction thereof which is a direction substantially opposite to the display direction A in which the display panel 20 performs display.

Further, the illuminance sensor 3 may be configured so as to have directivity in a specific direction. For example, the illuminance sensor 3 may be configured so as to have directivity in the rear direction of the display panel 20 which is substantially perpendicular to the display surface of the display panel 20.

An example of the illuminance sensor 3 configured so as to have directivity will be described below with reference to FIG. 5. FIG. 5 shows another example of the method for attaching the illuminance sensor 3. In this example, the illuminance sensor 3 is covered with a cylindrical member 40. An upper part of the cylindrical member 40 is opened. The central axis of the cylindrical member 40 is substantially parallel to the z axis, and the radial direction thereof is substantially parallel to the xy plane. Thus, the illuminance sensor 3 can measure the intensity of light from the vertical direction on the rear surface 22 side of the display panel 20. In other words, the illuminance sensor 3 has directivity on the side of the display panel 20 opposite to the display surface 21.

Referring back to FIG. 3, the description will be continued. The radio communication unit 4 communicates with the control apparatus 100. The radio communication unit 4 may be a communication interface for performing radio communication.

The camera 5 is an image capturing apparatus. The camera 5 is, for example, a color camera or an infrared sensor. The camera 5 captures an image in a predetermined direction. The camera 5 captures an image, for example, from the sky toward the ground. By doing so, the camera 5 acquires a captured image including a target person present on the ground. The camera 5 sends the acquired captured image to the image processing unit 11.

The position detection sensor 6, for example, may perform positioning using a technology such as Global Navigation Satellite System (GNSS). The position detection sensor does not need to be provided in all drones, and may be provided only in a reference drone described later.

The main control unit 10 controls the operation of the drone D by controlling each of the functional units of the drone D. For example, the main control unit 10 acquires data detected by each of the atmospheric pressure sensor 1, the distance sensor 2, and the illuminance sensor 3, and information about a result of processing by the image processing unit 11. Further, for example, the main control unit 10 instructs the image processing unit 11, the flight control unit 12, the display control unit 13, and the display direction control unit 14 to execute processing of each of the functional units.

Further, the main control unit 10 also functions as a determination unit for performing backlit determination processing according to this embodiment. The backlit determination processing is processing for determining whether or not the display surface of the display panel 20 is in a backlit state when the display panel 20 displays display information.

The backlit state indicates a state in which it is assumed that the visibility of the display content is reduced by emitting light from the rear side of the display panel 20. The backlit state may occur in relation to a position of a light source, the display surface of the display panel 20, and a position of a target person. The light source is, for example, sunlight. The light source may be a fluorescent lamp or the like.

For example, it is assumed that the light source is sunlight and a target person on the ground sees the display panel 20 of the drone D in the sky. In a case where the sun is located on the rear side of the display panel 20, the display surface of the display panel 20 is in a backlit state when seen from the target person. In such a case, the visibility of display information displayed on the display panel 20 is reduced.

The main control unit 10 acquires the illuminance detected by the illuminance sensor 3, and determines whether or not the display surface of the display panel 20 is in a backlit state based on the acquired illuminance. Specifically, first, the main control unit 10 acquires, from the illuminance sensor 3, the illuminance of the display panel 20 in the rear direction thereof which is a direction substantially opposite to the direction in which the display panel 20 performs display. Next, the main control unit 10 compares the acquired illuminance with a predetermined threshold. If the acquired illuminance is equal to or greater than the threshold, the main control unit 10 determines that the display surface is in a backlit state. In this case, the main control unit 10 sends a notification that the display surface is in a backlit state to the control apparatus 100 as a backlit notification.

Further, if the display surface is in a backlit state, the main control unit 10 receives a movement instruction to move the drone D from the current position to a corrected position from the control apparatus 100. The corrected position indicates a position corrected from the initially specified position in order to move the drone D to a position where the display surface is not brought to a backlit state.

The main control unit 10 moves the drone D through the flight control unit 12 in accordance with the movement instruction received from the control apparatus 100. For example, the main control unit 10 moves the drone D from the specified position before the movement instruction is received to the corrected position specified in the movement instruction. By doing so, the drone D moves to a position different from the current position thereof.

The image processing unit 11 performs image processing on an image captured by the camera 5. The image processing unit 11 can perform image processing using a well-known image recognition technology etc. The image processing unit 11 extracts a target person from the captured image.

The flight control unit 12 controls the flight of the drone D. For example, the flight control unit 12 controls the movement of the drone D such as moving forward, changing its direction, moving up, and moving down. The flight control unit 12 may control the flight of the drone D so as to follow a target person extracted by the image processing unit 11.

The display control unit 13 controls the display of the display panel 20. For example, the display control unit 13 controls the turning on and off of each of the light emitting units 20a to 20d included in the display panel 20. By doing so, the display control unit 13 controls the light emitting units 20a to 20d so as to display information different from one another.

The display direction control unit 14 controls a direction in which the display panel 20 performs display. The display direction control unit 14 changes the direction of the display panel 20 by changing the angle of the display panel 20. Thus, the display direction control unit 14 can change the direction in which the display panel 20 performs display. For example, the display direction control unit 14 changes the direction of the display panel 20 by using a driving unit (not shown). The driving unit is configured so that it can tilt the display panel 20.

The display direction control unit 14 may control the direction in which the display panel 20 performs display so that the display panel 20 faces in the direction of a target person specified by the image processing unit 11. Alternatively, the display direction control unit 14 may specify a target person holding a radio device and then control the direction in which the display panel 20 performs display.

As described with reference to FIG. 2, the display panel 20 is a display unit for displaying display information. The display panel 20 performs display at a predetermined position in a space. As described above, the display panel 20 includes the light emitting units 20a to 20d, and the light emitting units 20a to 20d form the display surface.

### (Configuration of the Control Apparatus 100)

Next, the control apparatus 100 will be described. The control apparatus 100 is a control apparatus that controls the drones D. The control apparatus 100, for example, may be composed of an information processing apparatus such as a Personal Computer (PC).

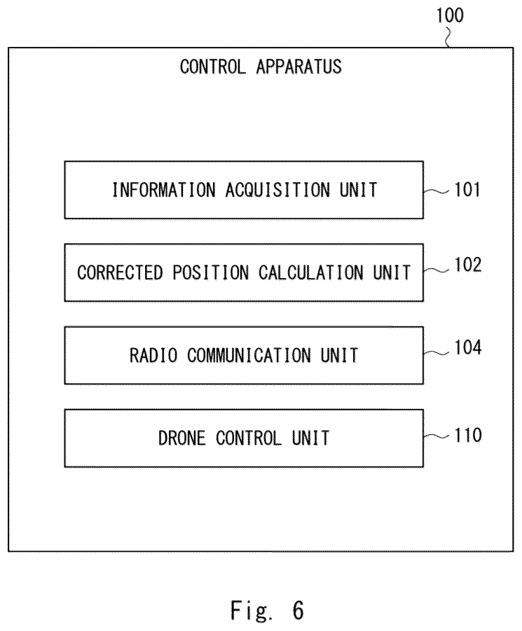

A configuration of the control apparatus 100 will be described with reference to FIG. 6. FIG. 6 is a block diagram showing the configuration of the control apparatus 100. As shown in FIG. 6, the control apparatus 100 includes an information acquisition unit 101, a corrected position calculation unit 102, a radio communication unit 104, and a drone control unit 110.

The information acquisition unit 101 acquires information from each of the plurality of drones D11, D12, D13, . . . . For example, the information acquisition unit 101 acquires position information of each of the drones D. Further, the information acquisition unit 101 acquires the illuminance measured by the illuminance sensor 3 provided in each of the drones D. The information acquisition unit 101 may acquire position information of a target person from each of the drones. The information acquisition unit 101 may acquire images captured by each of the drones.

The corrected position calculation unit 102 calculates a corrected position for correcting the position of the drone D. If it is determined that the display surface of the display panel 20 is in a backlit state, the corrected position calculation unit 102 calculates a position where the display surface of the display panel 20 is not brought to a backlit state as a corrected position. For example, a position shifted by a predetermined angle centered on a target person may be calculated as the corrected position, or a position shifted by a predetermined distance from the current position of the drone may be calculated as the corrected position.

The corrected position calculation unit 102 receives a backlit notification from the drone D, thereby recognizing that the display surface is in a backlit state. The corrected position calculation unit 102 may calculate a corrected position of the reference drone as a reference, or it may calculate a corrected position for each of the plurality of drones D11, D12, D13, . . .

The radio communication unit 104 communicates with the plurality of drones D11, D12, D13, . . . . The radio communication unit 104 may be a communication interface for performing radio communication.

The drone control unit 110 controls one or a plurality of drones. In this embodiment, the drone control unit 110 controls the plurality of drones D11, D12, D13, . . . . The drone control unit 110 can move the plurality of drones D11, D12, D13, . . . to respective specified positions and orderly arrange them, thereby forming a drone formation.

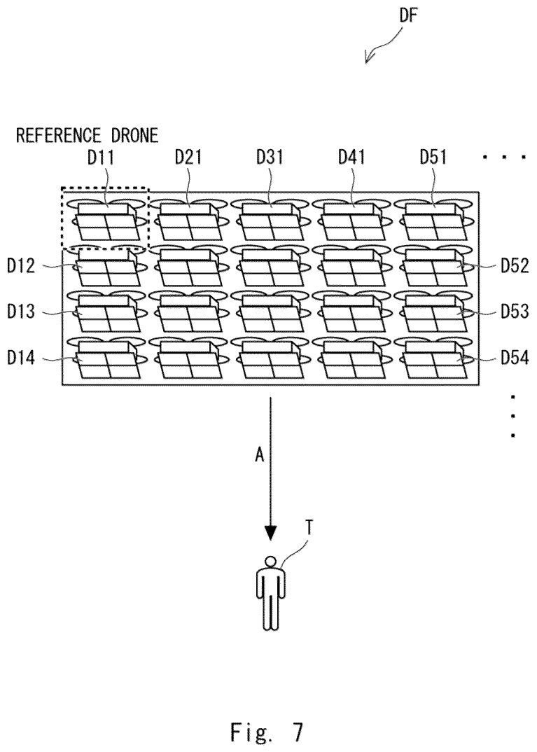

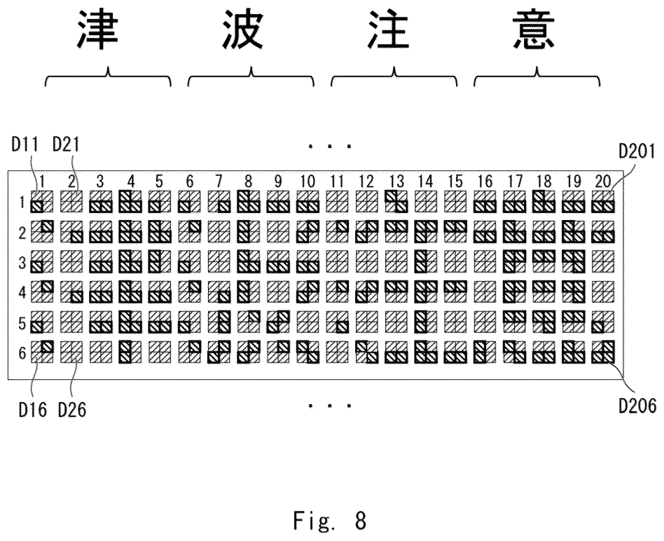

The drone formation (i.e., the plurality of drones forming a formation) will be described below with reference to FIGS. 7 and 8. FIG. 7 is a diagram showing an example of a drone formation DF formed by the plurality of drones D11, D12, D13, . . . . Further, FIG. 8 is a diagram showing an example of information displayed by the drone formation DF.

As shown in FIG. 7, the drone formation DF is formed by the plurality of drones D11, D12, D13, . . . which are orderly arranged. Since display is performed by a plurality of drones, there is a possibility that light from the opposite side of the display unit enters from a space between the adjacent drones, and hence the display of the display panel 20 becomes difficult to see. Therefore, in this embodiment, when the illuminance of the opposite side of the display panel 20 exceeds a predetermined value, it is determined that the display surface of the display panel 20 is in a backlit state, and then predetermined processing is performed.

The drone formation DF includes a reference drone as a reference for determining a position of the entire drone formation DF. In the example shown in FIG. 7, the drone D11 disposed at the upper left end of the drone formation DF when seen from a target person T is the reference drone. The reference drone can be set in advance by an administrator or the like of the control system 200. The reference drone may be a drone disposed at a position other than the upper left end of the drone formation DF.

The drone formation DF turns the display surface of the display panel 20 of each of the drones D toward the target person. In the example shown in FIG. 7, the drone formation DF adjusts the direction of the display panel 20 using a direction A where the target person is present as a direction in which display is performed.

The plurality of drones forming the drone formation DF turn on or off their own respective light emitting units 20a to 20d. By doing so, the drone formation DF forms one display as a whole (hereinafter referred to as a “whole display”). The whole display may include information such as characters and figures. The drone formation DF may change the whole display by changing its lighting mode at a predetermined timing.

Each of the light emitting units 20a to 20d included in a respective one of the drones corresponds to one dot among dots forming the whole display. Thus, one drone forms four dots in the whole display. The drone formation DF may be formed by adjusting the altitude of each of the drones in order to make the display surface uniform. The drone formation DF may display images in color.

FIG. 8 shows an example of the drone formation DF formed by 120 of the drones D11 to D206 displaying one message as a whole. As shown in FIG. 8, the drone formation DF displays the characters [symbol] (Beware of Tsunami) as a whole. In the example shown in FIG. 8, the parts where the light emitting units of the drones are off are shown by light hatching, while the parts where the light emitting units thereof are on are shown by dark hatching. For example, the lower left light emitting unit of the drone D11 is on, and the other three light emitting units thereof are off.

As shown in this example, the drone formation DF can function as an aerial display that is movable even when a disaster has occurred. Further, in normal times, the drone formation DF can display, for example, an advertisement.

When the drone control unit 110 moves the drone formation DF, the drone control unit 110 transmits information about the specified position to the drone formation DF. The drone control unit 110 may specify the position of the drone D11 by transmitting a movement instruction to the drone D11, which is the reference drone, and the other drones may be positioned based on the position of the drone D11.

Further, the drone control unit 110 moves the drone D to a different position when the illuminance detected by the illuminance sensor 3 is equal to or greater than a threshold, that is, when the display surface of the display panel 20 is in a backlit state. When a plurality of drones are controlled, the drone control unit 110 moves the plurality of drones so as to change distances between the plurality of drones based on the illuminance detected by at least one of the plurality of drones. For example, for the drone formation DF, the drone control unit 110 may perform control based on the illuminance of the reference drone, or may perform control based on the illuminance of each of a predetermined number of drones in the drone formation DF. The drone control unit 110 may control movements of the plurality of drones based on the illuminance detected by each of the plurality of drones.

When the display surface is in a backlit state, the drone control unit 110 transmits a movement instruction including the corrected position calculated by the corrected position calculation unit 102 to the drone formation DF. By doing so, the drone formation DF moves to the corrected position. Thus, the drone control unit 110 can move the drone formation DF to a position where the display surface is not brought to a backlit state even when there is a strong light source such as the sun or the moon on the rear of the drone formation DF.

Further, the drone control unit 110 may move the plurality of drones so that the distances between the drones are reduced. For example, the drone control unit 110 controls the plurality of drones D11, D12, D13, . . . so that the respective distances between them are reduced. The drone control unit 110 may specify the position of each of the drones. Alternatively, each of the drones D may adjust the distance between it and another drone D using the distance sensor 2. When the drones move toward one another, spaces between the drones are reduced, and hence the visibility of the whole display can be improved. Note that the drone control unit 110 may move the position of the entire drone formation DF while reducing the respective distances between the drones D.

Further, the drone control unit 110 transmits display information used to perform display to each of the drones D. The display information may include, for example, information about a light emitting unit(s) to be turned on among the light emitting units 20a to 20d, the time at which the light emitting unit(s) is to be turned on, and the like. The display information may also include information about the light emission luminance of the light emitting unit(s) to be turned on.

The drone control unit 110 may specify a target person using a camera or the like, and control the drone formation DF so as to follow the target person while changing the angle of the display surface.

The configuration of the control system 200 has been described above. Note that the configuration of the control system 200 described above is merely an example, and may be changed as appropriate. For example, when some or all of the components of the control system 200 are implemented by a plurality of information processing apparatuses, circuits, etc., the plurality of information processing apparatuses, the circuits, etc. may be disposed in one place in a concentrated manner or arranged in a discrete manner. For example, the information processing apparatuses, the circuits, etc. may be implemented in the form of a client server system, a cloud computing system, or the like in which the information processing apparatuses, the circuits, etc. are connected to each other through a communication network. Further, the functions of the control apparatus 100 may be provided in the form of Software as a Service (Saas).

Further, in this embodiment, although the control apparatus 100 is provided separately from the drone D, and the control apparatus 100 may be provided in the drone D. For example, the reference drone may automatically perform backlit determination processing and then, for example, instruct the other drones to move.

### (Processing of the Control System 200)

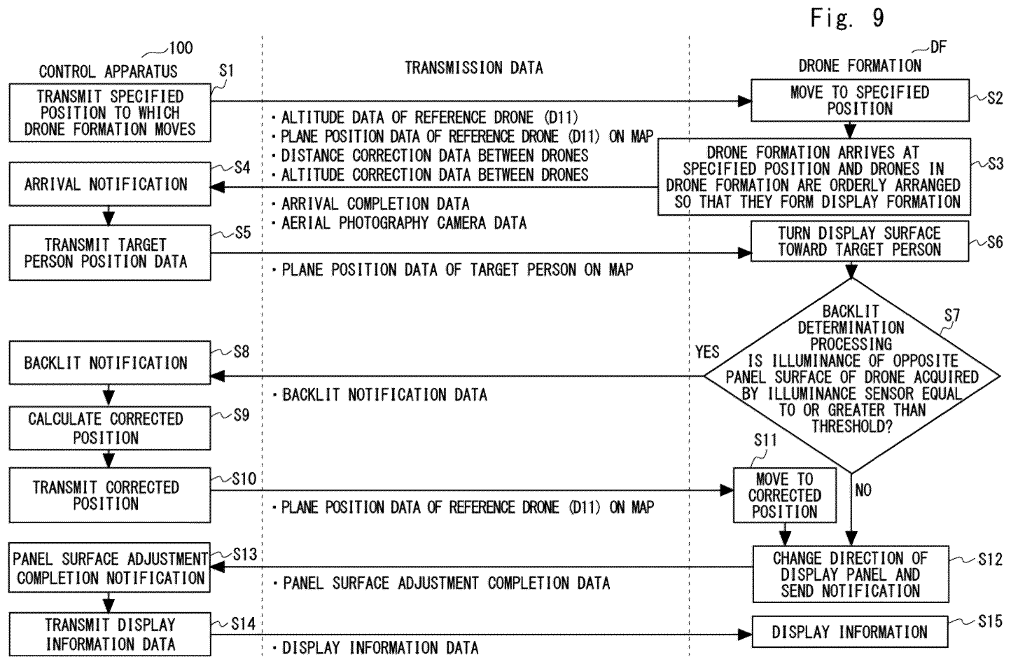

Next, processes performed by the control system 200 will be described with reference to FIG. 9. FIG. 9 is a sequence diagram showing control processing performed by the control system 200. As shown in FIG. 9, the control apparatus 100 and the drone formation DF transmit and receive various types of data shown in FIG. 9, thereby performing the control processing according to this embodiment. The following description will be given in accordance with the assumption that the drones D11 to D206 form the drone formation DF in order to perform the whole display as shown in FIG. 8.

First, the control apparatus 100 (the drone control unit 110) transmits, to the drone formation DF, the specified position to which the drone formation DF moves (S1). Each of the drones is configured so that it can position itself based on the altitude of the drone D11 (the reference drone) disposed at the upper left end of the formation and the plane position of the drone D11 on the map. The control apparatus 100 specifies the position of the drone D11, so that each of the drones automatically corrects the distances and the altitudes between the drones. As shown in FIG. 9, the control apparatus 100 transmits, to the drone formation DF, altitude data of the drone D11, plane position data of the drone D11 on the map, distance correction data between the drones, and altitude correction data between the drones.

Next, the drone formation DF moves to the specified position (S2). Further, when the drone formation DF arrives at the specified position, the drones D in the drone formation DF are orderly arranged so that they form a display formation (S3). The drone formation DF transmits an arrival notification for notifying that the drones D in the drone formation DF have been orderly arranged to the control apparatus 100. The arrival notification includes arrival completion data and aerial photography camera data.

The control apparatus 100 (the information acquisition unit 101) receives the arrival notification from the drone formation DF (S4). The control apparatus 100 transmits target person position data to the drone formation DF (S5). The target person position data includes plane position data of the target person on the map. The plane position data may be acquired by, for example, causing the drone D11, which is the reference drone, to specify a position of the target person. The drone D11 specifies the position of the target person from, for example, an image captured by a camera.

Next, the drone formation DF adjusts the direction of the display panel 20 so that the display surface of the display panel 20 faces the target person (S6). Further, the drone formation DF performs backlit determination processing for determining whether or not the display panel 20 is in a backlit state when seen from the target person (S7). For example, it is assumed that the drone D11 performs this processing. First, the drone D11 acquires, from the illuminance sensor 3, illuminance of the display panel 20 in the rear direction thereof which is a direction substantially opposite to the direction in which the display panel 20 performs display. Next, the drone D11 determines whether or not the illuminance is equal to or greater than a threshold. In this way, the drone D11 determines whether or not the display surface of the display panel 20 is in a backlit state due to the influence of sunlight or moonlight.

If the illuminance is equal to or greater than a threshold (YES in S7), the drone D11 transmits backlit notification data to the control apparatus 100. The backlit notification data is a notification for notifying the control apparatus 100 that the display surface of the display panel 20 is in a backlit state. If the illuminance is less than a threshold (NO in S7), the process proceeds to Step S12.

The control apparatus 100 (the information acquisition unit 101) receives the backlit notification from the drone formation DF (S8). The control apparatus 100 (the corrected position calculation unit 102) calculates a corrected position for moving the drone formation DF (S9). The control apparatus 100 (the drone control unit 110) transmits, to the drone formation DF, the corrected position to which the drone formation DF moves (S10). The control apparatus 100 transmits the plane position data of the drone D11 on the map, which is a reference of the drone formation DF, as the corrected position.

The drone formation DF moves to the corrected position based on the plane position data of the drone D11 on the map (S11). The drone formation DF changes the direction of the display panel 20 so that the display surface of the display panel 20 faces in the direction of the target person, and transmits a panel surface adjustment completion notification indicating that the direction of the display panel 20 has been changed to the control apparatus 100 (S12).

The control apparatus 100 (the information acquisition unit 101) receives the panel surface adjustment completion notification (S13). The control apparatus 100 (the drone control unit 110) transmits display information data to the drone formation DF (S14). The display information data includes display information for the drones to perform display at the respective positions. The drone formation DF receives the display information data and display the information (S15).

Note that, in the above example, although the drone formation DF performs the backlit determination processing, the control apparatus 100 may perform this processing. In this case, the drone formation DF transmits illuminance to the control apparatus 100, so that the control apparatus 100 can perform the backlit determination processing using the illuminance.

As described above, the control system 200 according to this embodiment determines whether or not the display surface of the display panel included in the drone is in a backlit state based on the illuminance of the rear of the display panel. By doing so, the display can be performed in a place where the display surface is not brought to a backlit state by changing the position of the drone if the display surface is in a backlit state. Further, the whole display can be easily seen by reducing the respective distances between the drones. Thus, the control system 200 can appropriately display information even during the daytime, which is easily affected by sunlight.

Since the control system 200 can move the drones to a place where there is no display apparatus and cause them to perform display in the air, it is possible, for example, to display necessary information from the sky to a target person on the ground when a disaster has occurred. Further, in normal times, the drones can be effectively used by displaying an advertisement or the like.

Further, since the control system 200 perform display using the light emitting units of the drones, the display content can be flexibly changed. Further, a target person can easily visually recognize the display content even at night.

Further, in the control system 200, a plurality of small drones can form a formation, to thereby provide a large display as a whole. Thus, there is no need to hang a large advertisement. Further, since the control system 200 can change a structure of the formation as appropriate, it is possible, for example, to provide a multi-plane display that does not limit a target person.

By the above configuration, the control system 200 can display information with high visibility by using a drone. In addition, in the control system 200, each of the drones can specify a target person by using a camera, an infrared sensor, or the like, and then can change the angle of the display surface and follow the target person, so that information can be continuously displayed to the target person.

Note that, in the above example, the main control unit 10 determines whether or not the display surface of the display panel 20 is in a backlit state based on the illuminance detected by the illuminance sensor 3, and if the main control unit 10 determines that it is in a backlit state, the drone control unit 110 controls the distances between a plurality of drones so as to be reduced. However, the present disclosure is not limited to the example in which the drone control unit 110 controls the distances between a plurality of drones so as to be reduced. If the illuminance detected by the illuminance sensor 3 is lower than a predetermined value, the drone control unit 110 may control the distances between a plurality of drones so as to be increased. That is, the drone control unit 110 may control the distances between a plurality of drones based on an illuminance value detected by the illuminance sensor 3. If the illuminance detected by the illuminance sensor 3 is lower than a predetermined value, the drone control unit 110 controls the distances between a plurality of drones so as to be increased, whereby a wider display can be performed.

### Second Embodiment

Next, a control system 200a according to a second embodiment will be described. The second embodiment is a modified example of the first embodiment. In the following description, differences between the first and the second embodiments are focused on, and redundant descriptions will be omitted as appropriate.

In the first embodiment, a description has been given of an example of a case in which when the display surface of the display panel 20 is in a backlit state, the drone is moved to escape from the backlit state. The control system 200a according to this embodiment adjusts at least one of a display brightness and a display color of the display panel 20 based on a color of a subject located on the rear of the drone.

### (Configuration of the Control System 200a)

The control system 200a according to this embodiment includes the plurality of drones D11, D12, D13, . . . , and a control apparatus 100a which can control this plurality of drones. The configuration of the control system 200a can be explained by replacing the control apparatus 100 of the control system 200 shown in FIG. 1 by the control apparatus 100a. Further, the configuration of the drone D according to this embodiment is substantially the same as that of the drone D shown in FIG. 3. Therefore, illustrations thereof will be omitted in this example.

The drone D according to this embodiment includes a color sensor for detecting the color of a subject by capturing an image of a space in the rear direction. In the following description, the camera 5 shown in FIG. 3 is used as the color sensor for detecting the color of a subject. As the color sensor, various sensors which can detect the color of a subject by capturing an image of the subject may be used. A color of a subject may be represented by, for example, color information using RGB values defined in an SRGB space.

The camera 5 captures an image of the space in the rear direction of the display panel 20 and detects the color of a subject. The subject is, for example, a sky or an object located on the rear side of the display panel 20. For example, the camera 5 is attached to the rear surface of the display panel 20 and captures an image of the space in the rear direction. Note that the drone D may be configured to include one sensor that also functions as the illuminance sensor 3 and the camera 5.

### (Configuration of the Control Apparatus 100a)

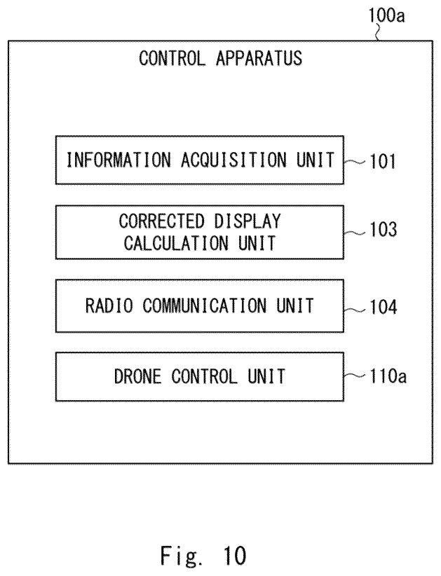

Next, the control apparatus 100a according to this embodiment will be described with reference to FIG. 10. FIG. 10 is a block diagram showing a configuration of the control apparatus 100a.

The control apparatus 100a includes the information acquisition unit 101, a corrected display calculation unit 103, the radio communication unit 104, and a drone control unit 110a. Unlike the control apparatus 100 according to the first embodiment, the control apparatus 100a includes the corrected display calculation unit 103 instead of including the corrected position calculation unit 102.

The corrected display calculation unit 103 calculates corrected display information based on illuminance detected by the illuminance sensor 3 and a color of a subject detected by the camera 5. The corrected display calculation unit 103 may calculate corrected display information by using both the illuminance and the color of the subject or by using either one of them.

The corrected display information is information for correcting at least one of a display brightness and a display color of the display panel 20. The corrected display information may include a corrected display brightness indicating the display brightness that has been corrected or a corrected display color indicating the display color that has been corrected. The corrected display information may include both the corrected display brightness and the corrected display color.

For example, the corrected display calculation unit 103 calculates a corrected display brightness obtained by correcting the display brightness of the display panel 20 based on the illuminance or the color of the subject. For example, the corrected display calculation unit 103 increases the display brightness of the display panel 20 when the illuminance is equal to or greater than a threshold. By doing so, the visibility of the display panel 20 is improved when the display surface of the display panel 20 is in a backlit state. The corrected display calculation unit 103 may reduce the display brightness in accordance with the illuminance.

For example, the corrected display calculation unit 103 calculates, using illuminance I and a threshold Th, a corrected display brightness L1 or L2 under the following conditions. In this case, L1<L2 holds.

(1) If I<Th:L1

(2) If I≥Th:L2

In this way, the corrected display calculation unit 103 can calculate a corrected display brightness in accordance with the illuminance of the display panel 20 in the rear direction thereof. The corrected display calculation unit 103 may acquire the illuminance at predetermined time intervals and calculate a corrected display brightness. By doing so, the corrected display calculation unit 103 can calculate an appropriate display brightness in accordance with the movement of the drone.

Note that, although the display brightness having two levels is shown in this example, the corrected display calculation unit 103 may adjust the display brightness using a larger number of levels. Further, the corrected display calculation unit 103 may calculate a correction value of the display brightness based on a value measured by the illuminance sensor 3 and adjust the display brightness using the correction value.

Further, when the drone D includes a plurality of illuminance sensors 3, the corrected display calculation unit 103 may calculate corrected display information using the illuminance detected by each of the plurality of illuminance sensors 3.

For example, the display panel 20 may have a structure in which the illuminance sensor 3 is provided on each of the display surface 21 and the rear surface 22 shown in FIGS. 4 and 5. By this structure, the two illuminance sensors 3 can detect both the illuminance of the display panel 20 on the display surface 21 side thereof and the illuminance of the display panel 20 on the rear surface 22 side thereof. Further, by attaching two of the illuminance sensors 3 using the attaching method shown in FIG. 5, the display panel 20 may include the illuminance sensor 3 having directivity in the display direction A and the illuminance sensor 3 having directivity in the rear direction of the display panel 20.

In this example, the illuminance sensor 3 attached to the rear surface 22 of the display panel 20 is defined as a first illuminance sensor 3a, while the illuminance sensor 3 attached to the display surface 21 of the display panel 20 is defined as a second illuminance sensor 3b. The corrected display calculation unit 103 may calculate a difference between the illuminance detected by the first illuminance sensor 3a and the illuminance detected by the second illuminance sensor 3b, and calculate a corrected display brightness based on the calculated difference. By taking into account the brightness of a surrounding environment detected by the second illuminance sensor 3b, the corrected display calculation unit 103 can perform a more appropriate brightness adjustment.

Further, the corrected display calculation unit 103 may calculate a corrected display color obtained by correcting the display color of the display panel 20 based on the illuminance or the color of the subject. For example, the corrected display calculation unit 103 calculates a corrected display color so that a brightness difference or a hue difference between the display of the display panel 20 and the color of the subject in the background is provided. For example, the corrected display calculation unit 103 calculates a corrected display color so that the display of the display panel 20 and the color of the subject in the background have a complementary color relationship with each other.

The drone control unit 110a controls the drone D based on the corrected display information calculated by the corrected display calculation unit 103. The drone control unit 110a controls at least one of the display brightness and the display color of the display panel 20.

### (Processing of the Control System 200a)

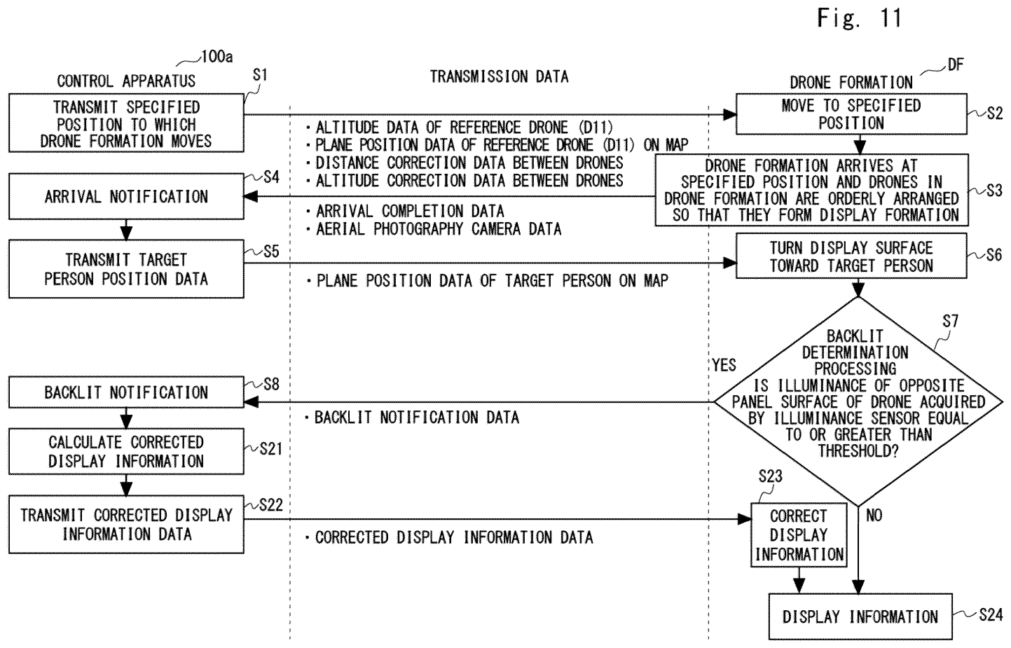

Next, processing of the control system 200a according to this embodiment will be described with reference to FIG. 11. FIG. 11 is a sequence diagram showing processes performed by the control system 200a. Since the processes of Steps S1 to S8 are similar to those according to the first embodiment shown in FIG. 9, the descriptions thereof will be omitted.

If the backlit notification is received in Step S8, the control apparatus 100a (the corrected display calculation unit 103) calculates corrected display information (S21). Next, the control apparatus 100a (the drone control unit 110a) transmits corrected display information data to the drone formation DF (S22). Then, the drone formation DF corrects display information displayed on the display panel 20 (S23), and displays the corrected display information (S24).

Note that, in the example shown in FIG. 11, the drone formation DF performs backlit determination processing and then transmits a backlit notification to the control apparatus 100a (S7, S8). However, the drone formation DF does not need to perform these processes. For example, the drone formation DF may simply transmit the illuminance and the color of the subject to the control apparatus 100a. Thus, the control apparatus 100a may calculate display information for improving visibility regardless of whether or not the drone is in a backlit state.

Further, although the control apparatus 100a calculates corrected display information in the above description, each of the drones D may perform this process. For example, the display control unit 13 of each of the drones D may calculate corrected display information based on a value detected by the illuminance sensor 3, and control at least one of the display brightness and the display color of the display panel 20.

As described above, in the control system 200a according to this embodiment, the illuminance sensor 3 detects illuminance of the display panel 20 in the rear direction thereof which is a direction substantially opposite to a direction in which the display panel 20 performs display. Further, the camera 5 captures an image of a space in the rear direction of the display panel 20 and detects the color of a subject.

Further, the control apparatus 100a controls at least one of a display brightness and a display color of the display panel 20 based on the illuminance and the color of the subject. In this way, the control system 200a can display information with high visibility by using a drone.

### (Example of a Hardware Configuration)

Each of the functional components of the control apparatuses 100 and 100a and the drone D described above may be implemented by hardware (e.g., a hard-wired electronic circuit) that implements the functional components, or may be implemented by a combination of hardware and software (e.g., a combination of an electronic circuit and a program for controlling the electronic circuit). For example, in the present disclosure, any processing can also be implemented by causing a CPU to execute a computer program.

The program includes instructions (or software codes) that, when loaded into a computer, cause the computer to perform one or more of the functions described in the embodiments. The program may be stored in any type of non-transitory computer readable media or tangible storage media. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (Registered Trademark) disc or other types of optical disc storage, a magnetic cassette, a magnetic tape, and a magnetic disk storage or other types of magnetic storage devices. Further, the program may be transmitted on any type of transitory computer readable media or communication media. By way of example, and not a limitation, transitory computer readable media or communication media can include electrical, optical, acoustical, or other forms of propagated signals.

Note that the present disclosure is not limited to the above-described embodiments and may be changed as appropriate without departing from the spirit of the present disclosure.

Further, the above embodiments may be implemented in any combination. For example, the first embodiment and the second embodiment may be implemented in combination. For example, the control system may control the drone so that the drone is moved to a place where the display surface is not brought to a backlit state based on illuminance and so that at least one of a display brightness and a display color of the display panel is controlled.

A control system and a control method according to the present disclosure can display information with high visibility by using a drone.

The present disclosure can be used for a drone and the like capable of moving in a space.

What is claimed is:

1. A control method for controlling a plurality of drones, each of the plurality of drones being configured to be movable in a space and perform display at a predetermined position, wherein the control method comprises:
moving at least one of the plurality of drones so that distances between the plurality of drones are changed based on illuminance in a direction substantially opposite to a direction in which the drone performs display, the illuminance being detected by at least one of the plurality of drones;
capturing an image in a predetermined direction from at least one of the plurality of drones;
extracting a target person from a captured image acquired by the capturing of the image; and
causing the display of each of the plurality of drones to face a direction in which the target person is present.

2. A control system comprising a plurality of drones and a control apparatus configured to control the plurality of drones, each of the plurality of drones being configured to be movable in a space, wherein
each of the plurality of drones comprises:
a display unit configured to perform display at a predetermined position in the space; and
an illuminance sensor configured to detect illuminance of the display unit in a rear direction thereof which is a direction substantially opposite to a direction in which the display unit performs display, and
the control apparatus:
moves at least one of the plurality of drones so that distances between the plurality of drones are changed based on the illuminance detected by at least one of the plurality of drones;
captures an image in a predetermined direction from at least one of the plurality of drones;
extracts a target person from a captured image acquired by the capturing of the image; and
causes the display of each of the plurality of drones to face a direction in which the target person is present.
